(19) United States
(12) Patent Application Publication
(10) Pub. No.: US 2019/0205473 A1
(43) Pub. Date: Jul. 4, 2019

(54) SOCIAL MEDIA INFLUENCER ORCHESTRATION

(71) Applicant: Moves Media Ventures, LLC, Miami, FL (US)

(72) Inventors: Kelli Socol, Miami, FL (US); Jay Levy, Miami, FL (US)

(21) Appl. No.: 15/857,948

(22) Filed: Dec. 29, 2017

(51) Int. Cl. G06F 17/30

(52) U.S. Cl. CPC G06F 17/30867; G06Q 50/01; G06F 17/30554

(57) ABSTRACT

Embodiments of the present invention provide a method, system and computer program product for social media influencer orchestration. In an embodiment of the invention, a method for social media influencer orchestration includes detecting a social media posting, such as a short burst message, an image or a comment upon an image, to a social media channel through a computing device by a subject end user, monitoring the social media channel to determine an impact of the social media posting and querying a rules base with the determined impact to retrieve a recommendation corresponding to the determined impact. Thereafter, a prompt is rendered in the computing device with the recommendation.

### BACKGROUND OF THE INVENTION

### Field of the Invention

The present invention relates to the field of social media and more particularly to content management in social media.

### Description of the Related Art

Social media refers the collection of different, Internet connected communications channels that are each dedicated to community-based input, interaction, content-sharing and collaboration. Web sites and applications dedicated to forums, microblogging, social networking, social bookmarking, social curation, and wikis are among the different types of social media. Social media has proven to be an extraordinary media outlet for political thought, commercial thought, and most importantly, public relations. That is to say, individuals through the skilled utilization of social media are able to reach a vast number of individuals in the target audience at little or no cost in order to express a brief textual idea or image.

Social media has proven essential for those seeking to endorse the quality or nature of a consumer product. To that end, corporate interests frequently turn to social media in order to promote the sale of a product or service. A common tool reliant upon social media and utilized by corporate interests to promote the sale or a product or service includes engaging a celebrity to post social media content promoting the sales of the products or services. At its most basic form, the posted social media content may be an express endorsement. But more often than not, the posted social media content is an image showing the celebrity utilizing the product or service to be promoted—an implicit endorsement.

Of course, celebrity endorsements of products or services through social media differ little from more traditional celebrity endorsements in that the manufacturer or distributor of the subject product or service pays or otherwise compensates the celebrity to directly promote a product or service, or to indirectly promote the product or service by appearing publicly to use or consume a product or service. Celebrities able to receive such endorsement deals profit handsomely. Yet, for a celebrity to receive such an endorsement deal, the celebrity must be an “influencer”. In social media parlance, an “influencer” is an individual or organization who demonstrably has a large set of followers who read and repost or otherwise indicate an interaction with the social media contributions of the individual or organization. The most common form of influencing is an individual or organization who uploads a textual comment or an image with commentary onto social media which textual commentary or image with commentary is then reposted by the followers of the individual or organization.

Becoming an influencer is no small feat. Being a celebrity alone is no guarantee of becoming an influencer. One most know the type of content to post, the frequency in which to post content and, just as importantly, the type of content not to post. As well, knowing how to respond to the commentary of one's own post oftentimes determines the degree to which one is able to influence the opinions of others online. As such, it will be apparent that becoming and remaining an influencer is more art form than anything else. Consequently, most celebrities do not achieve influencer status and therefore, do not have access to lucrative endorsement arrangements for products and services.

### BRIEF SUMMARY OF THE INVENTION

Embodiments of the present invention address deficiencies of the art in respect to social media post creation and provide a novel and non-obvious method, system and computer program product for social media influencer orchestration. In an embodiment of the invention, a method for social media influencer orchestration includes detecting a social media posting, such as a short burst message, an image, video or a comment upon an image, to a social media channel through a computing device by a subject end user, monitoring the social media channel to determine an impact of the social media posting and querying a rules base with the determined impact to retrieve a recommendation corresponding to the determined impact. Thereafter, a prompt is rendered in the computing device with the recommendation.

In one aspect of the embodiment, the impact is a sentiment of one or more viewers of the social media posting computed based upon a textual analysis of a reply to the social media posting in the social media channel. In another aspect of the embodiment, the impact is a tone of the social media posting computed based upon a textual analysis of the social media posting. In yet another aspect of the embodiment, the impact is a quantified number of interactions with the social media posting in the social media channel. In even yet another aspect of the embodiment, the impact is an anticipated impact of the social media posting predicting any combination of a number of views, number of “likes”, number of shares and even a probability that the posting “goes viral”. Finally, in even yet another aspect of the embodiment, the recommendation is a modification of the social media posting replacing words associated with one emotion such as joy, surprise, sadness, fear, aggression, anger, disgust or contempt, with words associated with a different emotion determined to be desirable.

In another embodiment of the invention, a social media data processing system is adapted for social media influencer orchestration. The system includes a host computing device with memory and at least one processor and a network adapter transmitting data over and receiving data from a communications link to the global Internet. The system also includes at least one social media channel application executing in the memory of the device and including a configuration to receive data input in a user interface to the application and to post the data input as a social media posting to a corresponding social media channel disposed accessible over the communications link to the global Internet. Finally, the system includes a social media influencer module coupled to the at least one social media channel application.

The module includes program code enabled during execution in the device to detect a social media posting to the social media channel in the application, to monitor the social media channel to determine an impact of the social media posting, to query a rules base with the determined impact to retrieve a recommendation corresponding to the determined impact and to render a prompt in a display of the device with the recommendation. In this regard, the rules base may be disposed in the memory of the device, or the rules base may be disposed over the global Internet in a remote repository accessed by the program code of the module by way of the communications link. As well, the social media channel may be monitored locally by the program code of the module, or remotely from the device over the global Internet with the determined impact transmitted to the device through the communications link.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for social media influencer orchestration;

FIG. 2 is a block diagram illustration a social media data processing system adapted for social media influencer orchestration; and,

FIG. 3 is a flow chart illustrating a process for social media influencer orchestration.

### DETAILED DESCRIPTION OF THE INVENTION

Embodiments of the invention provide for social media influencer orchestration. In accordance with an embodiment of the invention, the postings of a subject end user to different social media channels are monitored and an impact of each of the postings measured. For instance, the impact may be a measured sentiment of one or more viewers of a corresponding one of the postings, a volume of engagement by different viewers of a corresponding one of the postings, or a computed tone of a corresponding one of the postings. A rules base is then consulted for each posting with respect to the type of the posting and a corresponding impact to retrieve a recommendation as to creating a follow-on posting. Thereafter, the recommendation is presented to the subject end user and the process can repeat. Optionally, the postings of others in the social media channels are monitored and the rules base consulted for each of the postings of the the others in order to retrieve a recommendation as to creating a follow-on posting for presentation to the subject end user.

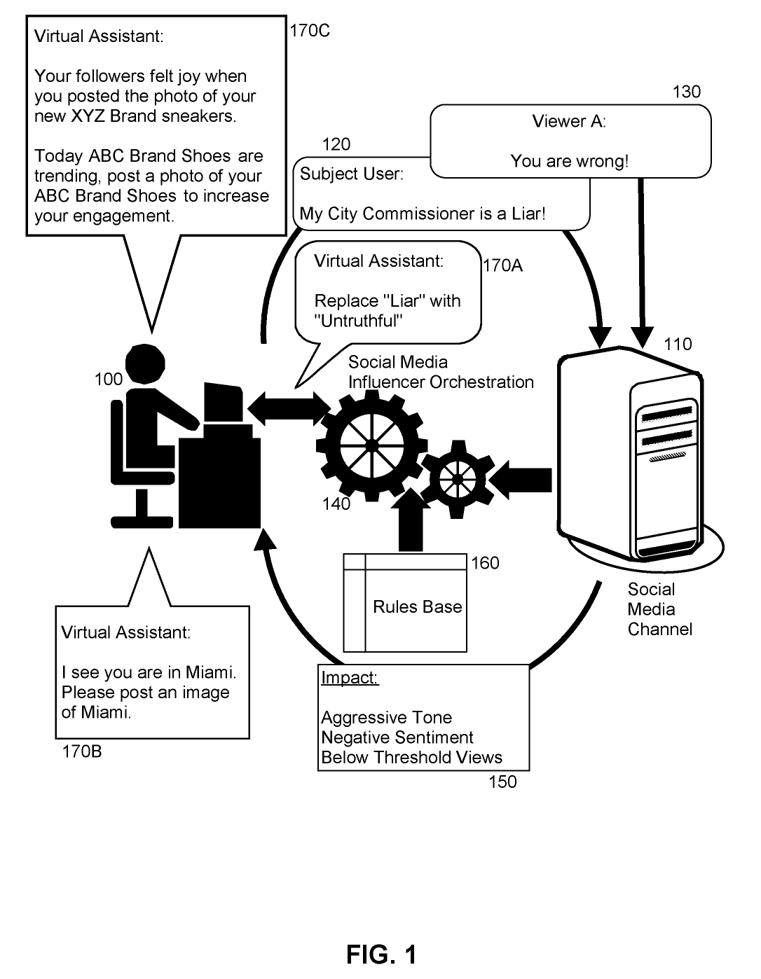

In further illustration, FIG. 1 is pictorial illustration of a process for social media influencer orchestration. As shown in FIG. 1, a subject end user 100 provides a social media posting 120 to a social media channel 110. Social media influencer orchestration logic 140 analyzes the text of the social media posting 120 to identify a tone of the social media posting 120 such as passive, aggressive, fun, serious, sad or happy utilizing natural language processing of the text of the posting, or by simply parsing the terms of the text and identifying in a lexicon words associated with a particular tone such that a predominance of a certain number of words associated with a particular tone results in a tone being determined for the social media posting 120. Optionally, the social media influencer orchestration logic 140 may characterize the social media posting 120 as a combination of different tones each being weighted according to a predominance of corresponding terms of one of the different tones relative to remaining ones of the different tones—for example, 20% aggressive, 30% sad and 50% neutral.

The social media influencer orchestration logic 140 also may monitor one or more replies 130 to the social media posting 120 by respective viewers of the social media posting 120 in order to compute a sentiment of the replies 130. The social media influencer orchestration logic 140 may compute the sentiment through natural language processing of the text of the replies 130, or by simply parsing each term in the replies 130 and for each identifying in a lexicon of words associated with a particular sentiment such that a predominance of a certain number of words associated with a particular sentiment results in a specific sentiment being computed for the corresponding one of the replies 130. Optionally, the sentiment of each of the replies 130 may be determined by submitting each of the replies 130 to a deep neural network trained for identifying the sentiment of a corpus of text so as to receive in response, a computed sentiment.

Even further, the social media influencer orchestration logic 140 may parse the social media posting 120 prior to transmission or subsequent to posting in order to predict an effectiveness of the social media posting 120. In this regard, at its most basic form, one or more recognized terms in the social media posting 120 may be located in a data store of past postings and corresponding known effectiveness of the past posting such as reach, impressions, re-postings, and the like in order to predict an effectiveness of the social media posting 120. In a more advanced form, model-based predictions may be the result of classifying the social media posting 120, determining a demographic audience of the social media posting 120, and recalling a model based upon the classification and determined demographic audience.

As well, different modes of predicting the effectiveness of the social media posting 120 may be utilized with each method receiving a weight depending upon a known quality of each method such as the circumstance in which the model-based predictions lack a requisite quantity of data. Thereafter, the weighted results of each mode of prediction may be aggregated into a single predictive value of effectiveness for the social media posting 120. The weights may then change dynamically over time as the requisite data for the model improves.

Finally, the social media influencer orchestration logic 140 may monitor a number of interactions with the social media posting 120 in order to compute an effectiveness and reach of the social media posting 120. For instance, a number of impressions or a number of views for the social media posting 120 may be determined. As well, a number of replies 130 to the social media posting 120 may be determined including “likes” or other simplistic indicators. Optionally, a number of instances of different social media members requesting to establish a connection with the subject end user following the social media posting 120 before a next social media posting may be counted as a number of interactions resulting from the social media posting 120. Thereafter, one or more of the foregoing may be included as an impact 150 of the social media posting 120.

Consequently, the social media influencer orchestration logic 140 queries a rules base 160 with the impact 150 in order to determine a corresponding recommendation. In this regard, the rules base 160 includes a sets of recommendations corresponding to one or more different impacts. Examples include:

Tone is Aggressive: Recommend modifying posting with less aggressive term
Tone is Passive: Recommend modifying posting with more aggressive term
Sentiment is Positive: Recommend creating follow-on posting
Sentiment is Negative: Recommend creating conciliatory posting
Interactions Low: Recommend creating follow-on posting
Interactions High: Identify posting leading to high interactions
Once one or more rules in the rules base 160 are determined to be applicable, the social media influencer logic 140 displays a prompt 170A, 170B, 170C with the located recommendations. As can be seen, exemplary prompt 170A recommends replacing a term in the social media posting 120 with a different term known to be less aggressive and conciliatory so as to address the determined tone and/or determined negative sentiment of the social media posting 120 in the impact 150.

In particular, and by way of example, the tone for each comment presented by each subject end user can be identified based upon term matching or natural language processing of each comment. A table of tones can be accessed keyed on the matched terms of the natural language processing of the comment and can product a sentiment as the impact 150 of sarcasm, irony, wit, anger, happiness, joy, etc. Then, a frequency of determined tones can be computed with the distribution of the frequency specifying the overall impact 150 of the social media posting 120. Optionally, the impact can be reduced to “positive”, “neutral” and “negative” impact with different tones being assigned one of the foregoing and the entire distribution of impacts being presented according to percentage distribution.

Optionally, the rules base 160 may include rules pertaining to a context of the subject end user 100. Examples include:

Particular Location: Recommend posting an image of current location
Particular Time: Recommend posting at a particular time
Particular Day: Recommend posting pertinent to day of week/month/year
Trending News Item: Recommend posting pertinent to news item
Calendar Entry: Recommend posting pertinent to calendar entry
As such, exemplary prompt 170B recommends posting an image or text pertaining to a determined location of the subject end user 100, though other prompts may call for wishing someone a Happy Birthday based upon a calendar entry, or wishing one good luck in participating in an event that has been calendared. As well, exemplary prompt 170C recommends the subject end user create a posting pertaining too a product name that is determined to be trending, or in the alternative, a news item that has been trending such as a recommendation to post an image of the end user 100 wearing a particular brand of clothing or accessory, or a recommendation to post a thought pertaining to a newsworthy event.

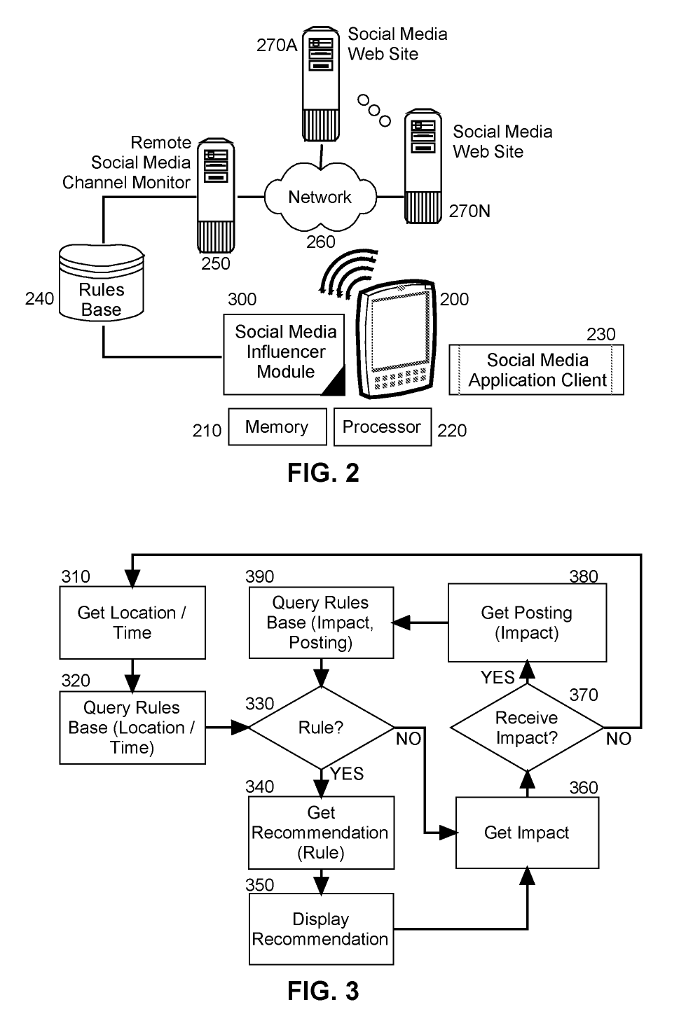

The process described in connection with FIG. 1 may be implemented in a social media data processing system. In further illustration, FIG. 2 is a block diagram illustration a social media data processing system adapted for social media influencer orchestration. The system includes a host computing device 200, for instance a smart phone or tablet computer wireless coupled utilizing communications link to one or more social media Web sites 270A, 270N over computer communications network 260, for instance the global Internet. The host computing device 200 includes memory 210 and at least one processor 220. A social media application client 230 executes in the memory 210 of the host computing device 200 and provides a user interface through which postings are submitted to a corresponding one of the social media Web sites 270A, 270N.

Of note, a social media influencer module 300 additionally executes in the memory 210 of the host computing device 200. The social media influencer module 300 includes program code enabled during execution in the host computing device 200 to monitor the impact of different social media postings in the different social media Web sites 270A, 270N and to locate in communicatively coupled rules base 240, a corresponding rule matching the impact to a recommendation. In this regard, as can be seen, the rules base 240 may be disposed locally in the host computing device 200, or remotely in a remote social media channel monitor 250 accessible over the computer communications network 260. The program code of the social media influencer module 300 is yet further enabled to display a prompt in a display of the host computing device 200 including the recommendation of the matching rule.

In yet further illustration of the operation of the social media influencer module 300, FIG. 3 is a flow chart illustrating a process for social media influencer orchestration. Beginning in block 310, a location, date and time of a host computing device is determined. In block 320, the rules base is then queried with the location, date and time to determine, in decision block 330, if a matching rule exists. If so, in block 340 a recommendation corresponding to the rule is retrieved and in block 350 the recommendation is displayed in the host computing device. In decision block 330, however, if a rule in the rules base corresponding to the location, date and time cannot be located, in block 360, an impact computed for a social media posting is retrieved.

In decision block 370 it is determined if an impact has been received. If so, in block 380 a social media posting corresponding to the impact is determined and in block 390 the rules base is queried with the impact and identified posting. In decision block 330, if a corresponding rule matching the impact and identified posting is located, in block 340 a recommendation corresponding to the rule is retrieved and in block 350 the recommendation is displayed in the host computing device.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for social media influencer orchestration comprising:
detecting a social media posting to a social media channel through a computing device by a subject end user;
monitoring the social media channel to determine an impact of the social media posting;
querying a rules base with the determined impact to retrieve a recommendation corresponding to the determined impact; and,
rendering a prompt in the computing device with the recommendation.

2. The method of claim 1, wherein the social media posting is a posting selected from the group consisting of a short burst message, an image, a video, a comment on an image and an image.

3. The method of claim 1, wherein the impact is a sentiment of one or more viewers of the social media posting computed based upon a textual analysis of a reply to the social media posting in the social media channel.

4. The method of claim 1, wherein the impact is a tone of the social media posting computed based upon a textual analysis of the social media posting.

5. The method of claim 1, wherein the impact is a quantified number of interactions with the social media posting in the social media channel.

6. The method of claim 1, wherein the recommendation is a modification of the social media posting replacing words associated with one emotion with words associated with a different emotion.

7. A social media data processing system adapted for social media influencer orchestration, the system comprising:
a host computing device with memory and at least one processor and a network adapter transmitting data over and receiving data from a communications link to the global Internet;
at least one social media channel application executing in the memory of the device, the application comprising a configuration to receive data input in a user interface to the application and to post the data input as a social media posting to a corresponding social media channel disposed accessible over the communications link to the global Internet; and,
a social media influencer module coupled to the at least one social media channel application, the module comprising program code enabled during execution in the device to detect a social media posting to the social media channel in the application, to monitor the social media channel to determine an impact of the social media posting, to query a rules base with the determined impact to retrieve a recommendation corresponding to the determined impact and to render a prompt in a display of the device with the recommendation.

8. The system of claim 7, wherein the social media posting is a posting selected from the group consisting of a short burst message, an image, a video, a comment on an image and an image.

9. The system of claim 7, wherein the impact is a sentiment of one or more viewers of the social media posting computed based upon a textual analysis of a reply to the social media posting in the social media channel.

10. The system of claim 7, wherein the impact is a tone of the social media posting computed based upon a textual analysis of the social media posting.

11. The system of claim 7, wherein the impact is a quantified number of interactions with the social media posting in the social media channel.

12. The system of claim 7, wherein the recommendation is a modification of the social media posting replacing words associated with one emotion with words associated with a different emotion.

13. The system of claim 7, wherein the rules base is disposed over the global Internet in a remote repository and accessed by the program code of the module by way of the communications link.

14. The system of claim 7, wherein the social media channel is monitored remotely from the device over the global Internet with the determined impact transmitted to the device through the communications link.

15. A computer program product for social media influencer orchestration, the computer program product including a computer readable storage medium having program instructions embodied therewith, the program instructions executable by a device to cause the device to perform a method including:
detecting a social media posting to a social media channel through a computing device by a subject end user;
monitoring the social media channel to determine an impact of the social media posting;
querying a rules base with the determined impact to retrieve a recommendation corresponding to the determined impact; and,
rendering a prompt in the computing device with the recommendation.

16. The computer program product of claim 15, wherein the social media posting is a posting selected from the group consisting of a short burst message, an image, a video, a comment on an image and an image.

17. The computer program product of claim 15, wherein the impact is a sentiment of one or more viewers of the social media posting computed based upon a textual analysis of a reply to the social media posting in the social media channel.

18. The computer program product of claim 15, wherein the impact is a tone of the social media posting computed based upon a textual analysis of the social media posting.

19. The computer program product of claim 15, wherein the impact is a quantified number of interactions with the social media posting in the social media channel.

20. The computer program product of claim 15, wherein the recommendation is a modification of the social media posting replacing words associated one emotion with words associated with a different emotion.
